(19) United States
(12) Patent Application Publication
(10) Pub. No.: US 2025/0089933 A1
(43) Pub. Date: Mar. 20, 2025

(54) WATER FILTER ASSEMBLY FOR HOUSEHOLD APPLIANCE RESERVOIR

(71) Applicant: Haier US Appliance Solutions, Inc., Wilmington, DE (US)

(72) Inventors: Zhihua Liu, Louisville, KY (US); Samuel Vincent DuPlessis, Louisville, KY (US)

(21) Appl. No.: 18/470,015

(22) Filed: Sep. 19, 2023

(51) Int. Cl. A47J 31/60; A47J 31/44; A47J 31/46

(52) U.S. Cl. CPC A47J 31/605; A47J 31/446; A47J 31/461

(57) ABSTRACT

A water filter assembly for a household appliance having a removable reservoir includes a filter cage received within a carriage and a filter element positioned within the filter cage, the filter element comprising a filter medium in a fabric shell with an elastomeric perimetral skirt at one end, wherein the perimetral skirt sealingly engages a portion of the filter cage.

### FIELD OF THE INVENTION

The present disclosure relates generally to water filters for household appliances, in particular to water filters for household appliances having water reservoirs.

### BACKGROUND OF THE INVENTION

Many household appliances, in particular kitchen countertop appliances, process a quantity of water in the normal course of operating the appliance. Such appliances may include coffee makers, espresso machines, electric tea kettles, and the like. In many cases, the kitchen countertop appliance may include a water reservoir to facilitate one or more operating cycles of the appliance without refilling. The reservoirs are removable by a user to present to a water supply, for example tap water, for refilling a quantity of water and replaceable to provide water to the appliance.

Replaceable filters are often included in a reservoir to remove or limit odors, taste, or particulate matter that may be present in the water supply. Filter cartridges are typically received in a basket disposed in a water flow with unfiltered water on one side of the filter cartridge and filtered water on the other. The filter cartridges may fit loosely in the basket allowing for some volume of the unfiltered water to bypass the filter (i.e., between the filter and the basket) and become mixed with the filtered water, thus decreasing the filter effectiveness.

In many reservoirs, the filter and filter basket are mounted to a bottom wall of the interior volume of the reservoir, making removal and replacement of the filter difficult. In some cases, the removal and replacement of the filter is further complicated by the use of a tool to remove/replace the filter.

Accordingly, a water filter assembly addressing at least the above concerns may be beneficial.

### BRIEF DESCRIPTION OF THE INVENTION

Aspects and advantages of the invention will be set forth in part in the following description, may be apparent from the description, or may be learned through practice of the invention.

In one exemplary aspect, a water filter assembly for a household appliance having a removable reservoir is presented. The household appliance defines an axial direction and a radial direction. The water filter assembly comprises a filter cage received within a carriage, and a filter element positioned within the filter cage, the filter element comprising a perimetral skirt, wherein the perimetral skirt sealingly engages a portion of the filter cage.

In another exemplary aspect, a household appliance defining a radial direction and an axial direction is presented. The household appliance comprises a removable reservoir, a water filter assembly comprising a filter cage received within a carriage, and a filter element positioned within the filter cage. The filter element comprises a perimetral skirt wherein the perimetral skirt sealingly engaging a portion of the filter cage.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an exemplary countertop appliance for use with embodiments of the present disclosure;

FIG. 2 provides an exploded view of a reservoir and water filter assembly in accordance with an embodiment of the present disclosure;

FIG. 3 provides a perspective view of an embodiment of a carriage in accordance with the present disclosure;

FIG. 4 provides a perspective view of an embodiment of a carriage in accordance with the present disclosure;

FIG. 5 provides a bottom perspective view of a reservoir for use with embodiments of the present disclosure;

FIG. 6 provides a sectional view of a filter cage in accordance with embodiments of the present disclosure;

FIG. 7 provides a perspective view of a filter element in accordance with embodiments of the present disclosure;

FIG. 8 provides a sectional view of the filter element of FIG. 7; and

FIG. 9 provides a top view of the filter element of FIG. 7.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise. “Top” and “bottom” are used herein to distinguish the vertically upper and lower portions, respectively, of the described element or component discussed when in the normal orientation for use. In general, this would correspond to the orientation of the axis of the element parallel to the vertical direction as defined herein.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

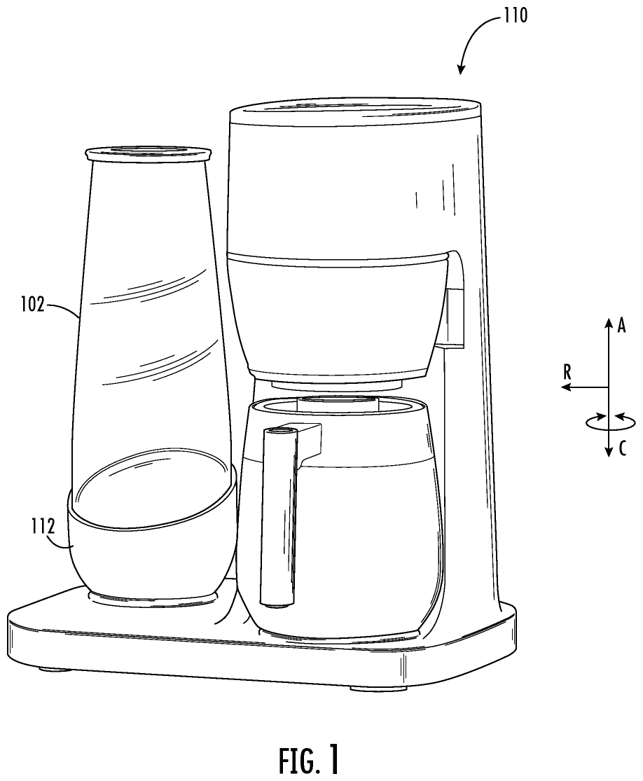

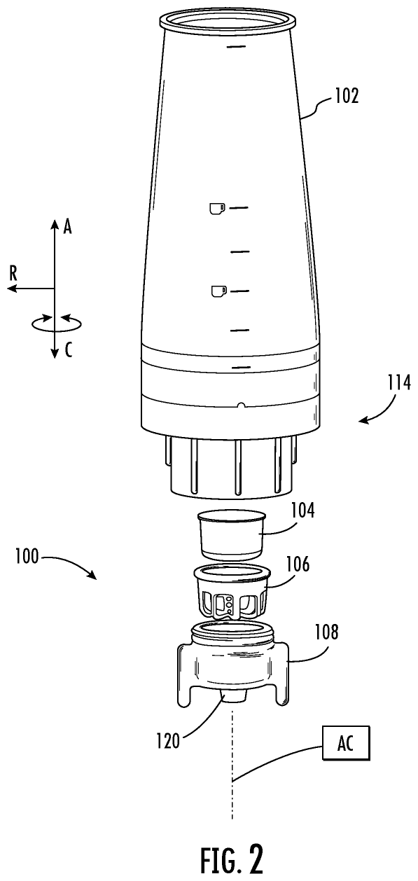

Turning to the figures, FIG. 1 illustrates an exemplary kitchen countertop appliance 110 that may utilize the disclosed water filter assembly 100. As illustrated, a reservoir 102 may be removably received into the appliance 110, for example in a base 112. The reservoir 102 may be removed from the base 112 for filling with water and replaced in the base 112 to provide the water to the appliance 110. As described in greater detail below, a normally closed check valve 120 (FIG. 2) may be provided at the vertical bottom of the filter assembly 100, for example in the carriage 108, the check valve 120 operable between a closed position when the reservoir 102 is separated from the base 112 and an open position when properly placed in the base 112. Components of the base 112 may interact with the check valve 120 to open the valve when the reservoir 102 is properly seated in the base 112. In other embodiments, the base 112 may open the check valve 120 when the appliance 110 makes a demand for water when the reservoir 102 is properly placed in the base 112.

The base 112 and the properly installed reservoir 102 cooperate to facilitate a flow of water from the reservoir 102 into the appliance 110. A water distribution system (not shown) within the appliance 110 transports the water from the reservoir 102, and may include a pump, one or more heaters, and all necessary tubing to direct the water flow. In the exemplary coffee maker of FIG. 1, the water distribution system directs a volume of water to a water heating device within the coffee maker to raise the temperature of the water to a prescribed brewing temperature. Once heated, the water is directed to a perforated nozzle (similar to a showerhead) for distribution of the heated water over a wide area of prepared ground coffee to brew a volume of coffee. Similar components may be provided for other kitchen counter appliances according to other embodiments. In some embodiments, other beverages, such as tea, may be brewed. In still other embodiments, water may be heated for a use other than brewing a beverage.

FIG. 2 provides an exploded view of a water filter assembly 100 that may be used in the exemplary household appliance 110 of FIG. 1, for example with reservoir 102, in accordance with an embodiment of this disclosure. The exemplary removable reservoir 102 (or simply reservoir 102), may be associated with the exemplary kitchen countertop appliance 110 (FIG. 1) or other appliances capable of processing a volume of water. The reservoir 102 is illustrated is having a generally cylindrical shape for ease of illustration only. The shape of the reservoir 102 may be any shape suitable for containing an amount of liquid (e.g., water). The exemplary countertop appliance 110 is illustrated as a coffee maker, but one of ordinary skill in the art will recognize the disclosed water filter assembly may be used with other kitchen countertop appliances, such as an espresso machine, an electric tea kettle, etc. Processing a volume of water may include filtering or heating, or both filtering and heating. In general, filter assembly 100 defines an axial direction A, a radial direction R extending outward from the axial direction A, and a circumferential direction C extending about axial direction A (e.g., three hundred sixty degrees (360°) about the axial direction A), with A, C, and R of the filter assembly aligned with A, C, and R of the exemplary countertop appliance 110. In addition, an axial centerline AC is defined by filter assembly 100 as shown in FIG. 1. As used herein, “radially inward” is a direction toward the axial centerline AC and “radially outward” is a direction opposite or away from the axial centerline AC.

Filter assembly 100 may be used with a water reservoir 102 containing a quantity of water for use in, for example, kitchen countertop appliances. Reservoir 102 may be removed from the appliance for filling with a volume of water from a domestic source, such as a private well or water utility, and replaced on the appliance 110. Removal of undesired components (e.g., particulate matter, taste, or odor) from the liquid may be helpful in producing a more palatable end product. The various embodiments of the present disclosure will be described with reference to the filtration of potable water for ease of description and understanding. However, the exemplary embodiments described and illustrated herein may be used for filtering other liquids as well.

An exemplary water filter assembly 100 is illustrated in an exploded view in FIG. 1. In embodiments, the filter assembly 100 comprises a filter cage 106 received within a carriage 108, and a filter element 104 positioned within the filter cage 106, the carriage 108, filter cage 106, and filter element 104 define a generally axial flow path generally parallel to axial centerline AC. When attached to the removable reservoir 102, the water filter assembly 100 (i.e., the carriage 108, filter cage 106, and filter element 104) cooperates with the reservoir 102 to define a generally axial flow path for water from the removable reservoir 102. In embodiments including a check valve 120, the defined flow path includes the check valve 120.

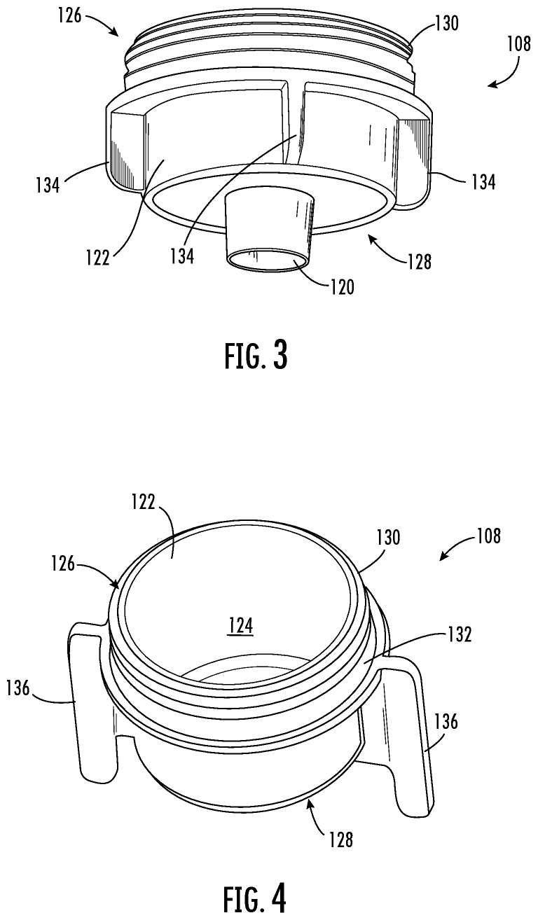

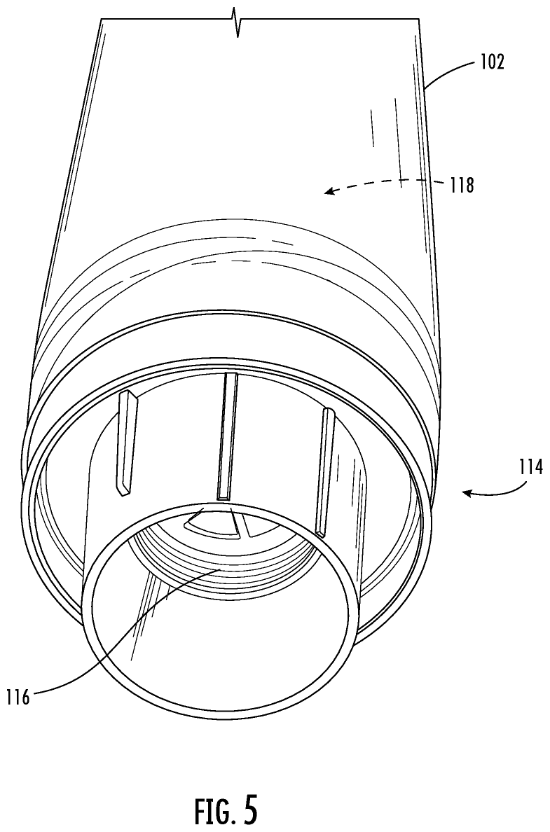

FIGS. 3 and 4 illustrate embodiments of carriages 108 in accordance with the present disclosure. The exemplary carriage 108 comprises a wall 122 defining an interior volume 124 to receive the filter cage 106, the interior volume 124 open at the vertically upper end 126, and generally closed at the vertically lower end 128 (“upper” and “lower” when oriented for use as in FIG. 1). The carriage 108 further includes a first mating portion 130 at the upper end 126 of the wall 122 that is configured to releasably engage with a second complementary mating portion 116 at the bottom portion 114 of the reservoir 102 (FIG. 5). The first and second mating portions 130, 116 may be threaded portions (i.e., one internal threaded section and a complementary external threaded section) as illustrated, sized and configured to axially align and rotationally couple the carriage 108 and reservoir 102 to removably attach the carriage 108 to the reservoir 102. The threads may be provided to facilitate formation of a watertight engagement of the carriage 108 with the reservoir 102. The threaded portions may cooperate to form the watertight engagement or the threaded portions may urge a portion of the reservoir 102 (e.g., the first mating portion) into contact with a portion of the carriage 108 (e.g., the second mating surface) to achieve the watertight engagement. In some embodiments, a sealing member or gasket 132 (FIG. 4) may be provided to facilitate formation of the watertight engagement.

In some embodiments, the first mating portion 130 and the second mating portion 116 may have other configurations useful in forming a watertight engagement. For example, the first mating and second mating portion 130, 116 may form a spiral cam lock coupling, such as a quarter turn coupling, to form a watertight seal. Other embodiments may have a snap or interference fit portions on the carriage 108 and reservoir 102 to achieve a watertight seal.

The carriage 108 may include gripping features 134, 136 (FIGS. 3 and 4) formed on an outside surface of the wall 122 to facilitate manual removal and installation of the carriage 108 to the reservoir 102 without the use of a separate tool or implement. For example, the carriage 108 may have elements such as gripping surfaces, tabs 134, or protrusions (for example radially extending wings 136) that assist a user in grasping and manipulating the carriage 108 to remove or attach the carriage 108 to the reservoir 102. A plurality of gripping features 134, 136 may be disposed around the perimeter of the carriage 108, spaced evenly from each other or spaced at other intervals. For example, as illustrated in FIG. 4 two gripping features, formed as radial tabs or wings 136, may be diametrically opposed to provide surfaces for the application of opposing forces (i.e., a torque) on the carriage 108 to facilitate the removal or attachment of the carriage 108 to the reservoir 102.

The check valve 120, discussed above, may be provided in a bottom surface (i.e., the generally closed vertically lower portion of second end 128) of the carriage wall 122 when the carriage 108 is mounted to the bottom portion 114 of the reservoir 102. In such configuration, the check valve 120 may be operated by the base 112 to an open position allowing fluid flow through the carriage 108 when the carriage 108 is properly installed in the base 112. Similarly, removing the carriage 108 from the base 112 operates the check valve 120 to a closed position, blocking fluid flow through the carriage 108. By selectively operating the check valve 120 between the open and closed positions, the check valve 120 selectively allows or blocks fluid communication, and fluid flow, from the interior volume 118 of the reservoir 102 to the appliance 110.

In embodiments, a filter cage 106 may be provided, the filter cage 106 configured (i.e., sized and shaped) to be received in the carriage 108. In the exemplary filter cage 106 of FIG. 5, the filter cage 106 comprises a perforated wall 140 defining an interior volume 142 and the outer profile 144. The outer profile 144 corresponds to, and is formed to be received within, the interior volume 124 of the carriage 108. The interior volume 142 of the filter cage 106 is open at a first end 146 (for example the vertically upper portion of FIG. 1) and is configured to accept a filter element 104. The wall 140 includes perforations allowing fluid communication through the wall (i.e., between the interior volume 142 of the filter cage 106 and the interior volume 124 of the carriage 108 when the filter cage 106 is received in the carriage 108), the perforations extending upward from the lower portion 148 of the filter cage 106 and ending towards the first end 146. An upper portion of the wall 150 proximate to the open portion of the interior volume142 is generally free of perforations. The upper portion 150 (i.e., the perforation-free portion) of the filter cage 106 may facilitate formation of a seal with the filter element 104 as will be described below.

The interior surface of the filter cage wall 140, forming an inner wall 154 (i.e., having a face directed radially inward), may include one or more axial ribs 152 generally aligned with the axial direction and extending radially inward. The ribs 152 may extend generally vertically (i.e., in the axial direction A) along a portion of the axial length of inner wall 154. The axial ribs may be disposed on the inner wall 154 from a location proximate to the lower portion 148, extending along the inner wall 154 at least partially towards the axial first end 146 of the filter cage 106. In some embodiments, the filter element 104 may include a perimetral skirt 160 with details 162 (e.g., notches) spaced about the perimeter 164 in locations corresponding to the axial rib 152 placement (discussed in greater detail below). The axial ribs 152 may beneficially guide the filter element 104 into the filter cage 106 for proper placement. Alternatively or additionally, the axial ribs 152 may prevent the filter element 104 from movement, for example rotation, within the filter cage 106.

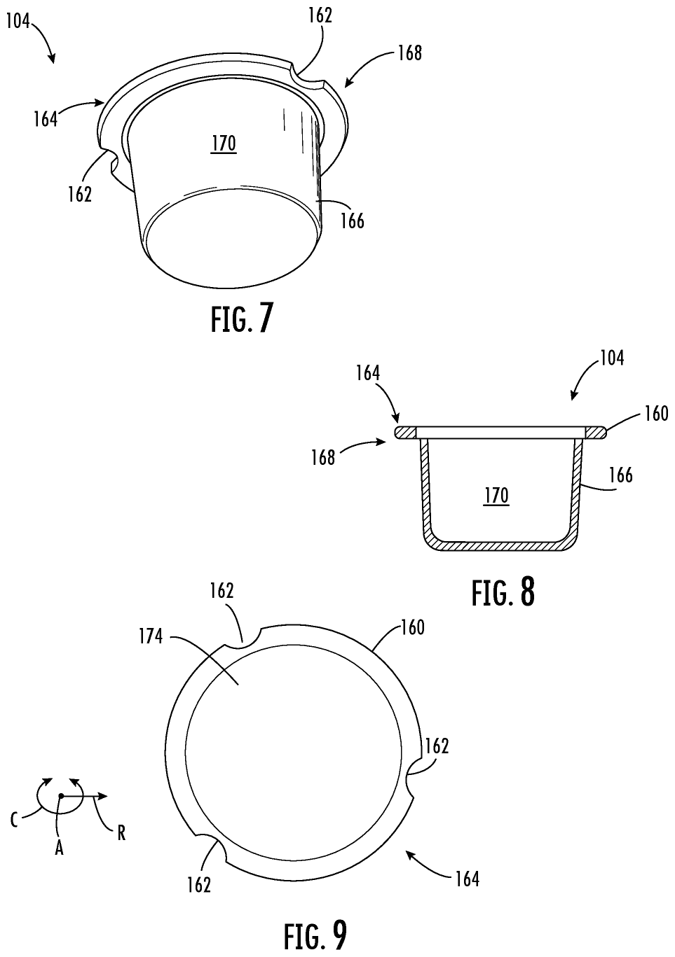

As illustrated in FIGS. 7 and 8, an exemplary filter element 104 comprises a water permeable fabric shell 166 defining an interior cavity 170 open at a first end 168. The fabric shell 166 may be shaped to be received in the interior volume 142 of filter cage 106 with the first end 168 proximate to the first end 146. The interior cavity 170 may accept a filter media 172, for example active carbon, either directly disposed in the interior cavity 170 or the media 172 may be first enclosed in a water permeable container and then disposed in the interior cavity 170. In other embodiments, different or additional filter media 172 can be used in the filter element 104. For example, filter media 172 may be an activated carbon block, carbon granules or powder with or without a binder, pleated sheets, melt-blown polypropylene, string wound filters, paper, various textiles, adsorption media, a combination thereof, or other suitable materials depending upon the filtration desired. The fabric shell 166 may be formed as a woven or nonwoven fabric to contain, or substantially contain, the filter media 172 within the filter element 104. A top 174 (FIG. 9) may be affixed to the open first end 168 of the fabric shell 166 to enclose the open volume 170 and contain the filter media 172. The top 174 is water permeable and may be comprised of the same or similar fabric and construction as the fabric shell 166 and, accordingly, having the same or similar properties.

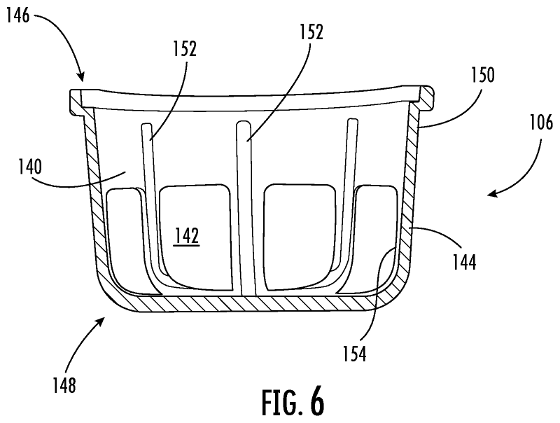

In the illustrative embodiment of FIGS. 6-8, the filter element 104 is generally cylindrical in shape, or a tapered cylinder, to correspond with a generally cylindrical interior volume 142 of the filter cage 106 as formed and defined by the perforated wall 140. According to other embodiments, the filter element 104 may have other shapes to cooperate with the shape of the interior volume 142 of filter cage 106. In embodiments, the filter element 104 may comprise an internal frame (not shown) to maintain the prescribed shape of the filter element 104. In other embodiments, the fabric shell 166 has sufficient rigidity to maintain the prescribed shape.

Continuing from above, according to embodiments, the fabric shell 166 may include a perimetral skirt 160 positioned at the upper portion 168 of the filter element 104 and formed at a perimeter 164 of the fabric top 174. The perimetral skirt 164 may be formed with, or added to, the filter element 104 such that the perimetral skirt 164 extends outwardly (i.e., generally in the R direction) beyond the fabric shell 166 of the filter element 104. The perimetral skirt 160 is configured (for example sized and shaped) to sealingly engage a portion of the filter cage 106, for example the upper, perforation-free, portion 150 of the filter cage 106. By sealing engaging with the upper portion 150 of the filter cage 106, the perimetral skirt 160 blocks, or substantially blocks, a fluid path between the filter element 104 and an inner wall 154 of the filter cage 106. Thus, the seal between the perimetral skirt 160 and the inner wall 154 of the filter cage 106 directs all, or substantially all, of the water flowing to the appliance 110 to pass through the filter element 104. Accordingly, all, or substantially all of the water passing from the reservoir 102 to the appliance 110 is filtered.

As discussed above, embodiments of filter cage 106 in accordance with this disclosure included axial ribs 152 disposed on the inner wall 154 of the perforated wall 140. Filter elements 104 used with a filter cage 106 comprising axial ribs 152 may include one or more features on the perimetral skirt 160 configured to accommodate the axial ribs 152 and sealingly engage with the ribs 152. For example, as illustrated in FIGS. 6 and 8, the perimetral skirt 160 may include one or more circular or semicircular notches 162 around the perimeter 164 of the perimetral skirt 160 to correspond with the location of the axial ribs 152. In other embodiments, the accommodating feature may be a notch of a different shape, one or more radial cuts in the skirt, or other detail to accommodate and sealingly engage with the axial ribs 152. The one or more notches 162 may engage the one or more axial ribs 152 to properly position the filter element 104 and secure the filter element 104 against rotation in the filter cage 106.

The perimetral skirt 160 may be formed as part of the fabric shell 166, the fabric top 174, or formed as a lip at the first end 168 of the filter element 104. In some embodiments, the perimetral skirt 160 may comprise a material, for example an elastomeric material (i.e., an elastomer) such as silicone or comprising silicone, applied over the lip formed as part of the fabric shell 166. In still other embodiments, the fabric shell 166 may be formed without a lip and the perimetral skirt 160 may be applied to the perimeter 164 of the first end 168 of the fabric shell 166. In embodiments including a material applied to the fabric shell 166, the material may be any compliant material suitable for contact with water, in particular potable water. In the embodiment above, silicone was disclosed as an exemplary material. Other materials may be used, including reinforced silicone, and other elastomers capable of sealing with the inner wall 154 of filter cage 106.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A water filter assembly for a household appliance having a removable reservoir, the household appliance defining an axial direction and a radial direction, the water filter assembly comprising:
a filter cage received within a carriage; and
a filter element positioned within the filter cage, the filter element comprising a perimetral skirt, wherein the perimetral skirt sealingly engages a portion of the filter cage.

2. The water filter assembly of claim 1, wherein the perimetral skirt is configured to block a fluid path between the filter element and an inner wall of the filter cage.

3. The water filter assembly of claim 1, wherein the perimetral skirt is formed from an elastomer.

4. The water filter assembly of claim 3, wherein the elastomer comprises silicone.

5. The water filter assembly of claim 1, wherein the filter element comprises a fabric shell defining an interior cavity, a filter media received in the interior cavity, a fabric top affixed to the fabric shell, the perimetral skirt formed at a perimeter of the fabric top.

6. The water filter assembly of claim 5, wherein the filter media comprises active carbon.

7. The water filter assembly of claim 1, wherein the filter cage comprises one or more axial ribs extending radially inward from a filter cage wall along a portion of a length of the filter cage; and
wherein the perimetral skirt includes one or more notches formed at a perimeter of the perimetral skirt to sealingly engage the one or more axial ribs.

8. The water filter assembly of claim 7, wherein the one or more notches engage the one or more axial ribs securing the filter element against rotation in the filter cage.

9. The water filter assembly of claim 1, wherein the carriage comprises:
a first mating portion; and
a bottom wall of the removable reservoir includes a second mating portion; and
wherein the first mating portion and the second mating portion releasably engage to form a watertight engagement.

10. The water filter assembly of claim 9, wherein:
the first mating portion and the second mating portion are configured to axially align and rotationally couple.

11. The water filter assembly of claim 10, wherein:
the first mating portion comprises a threaded section; and
the second mating portion comprises a complementary threaded section.

12. The water filter assembly of claim 1, wherein the carriage, the filter cage, and the filter element define an axial flow path for water from the removable reservoir.

13. The water filter assembly of claim 12, wherein the axial flow path includes a normally closed check valve configured to engage with a base, wherein engagement with the base positions the check valve in an open position facilitating a flow of water along the axial flow path from the removable reservoir.

14. The water filter assembly of claim 13, wherein the check valve is included in the carriage.

15. A household appliance defining a radial direction and an axial direction, the household appliance comprising:
a removable reservoir;
a water filter assembly comprising:
a filter cage received within a carriage; and
a filter element positioned within the filter cage, the filter element comprises a perimetral skirt; and
wherein the perimetral skirt sealingly engaging a portion of the filter cage.

16. The household appliance of claim 15, wherein the perimetral skirt is configured to block a fluid path between the filter element and an inner wall of the filter cage.

17. The household appliance of claim 15, wherein the perimetral skirt is formed from an elastomer comprising silicone.

18. The household appliance of claim 15, wherein the filter element comprises a fabric shell defining an interior cavity, a filter media comprising active carbon received in the interior cavity, a fabric top affixed to the fabric shell, the perimetral skirt formed at a perimeter of the fabric top.

19. The household appliance of claim 15, wherein the filter cage comprises one or more axial ribs extending radially inward from a filter cage wall along a portion of a length of the filter cage; and
wherein the perimetral skirt includes one or more notches formed at a perimeter of the perimetral skirt to sealingly engage the one or more axial ribs.

20. The household appliance of claim 19, wherein the one or more notches engage the one or more axial ribs securing the filter element against rotation in the filter cage.
